(19) United States
(12) Patent Application Publication
(10) Pub. No.: US 2017/0268921 A1
(43) Pub. Date: Sep. 21, 2017

(54) METHOD AND APPARATUS FOR DETECTING THE LEVEL OF A MEDIUM

(71) Applicant: HAWK MEASUREMENT SYSTEMS PTY. LTD., Victoria (AU)

(72) Inventors: Ravi VIVEKANANTHAM, Victoria (AU); Souren HARUTYUNYAN, Victoria (AU); Uditha Wijethilaka BANDARA, Victoria (AU)

(21) Appl. No.: 15/505,180

(22) PCT Filed: Aug. 12, 2015
(86) PCT No.: PCT/AU2015/000483

§ 371 Date: Feb. 20, 2017

(30) Foreign Application Priority Data
Aug. 21, 2014 (AU) 2014903290

(51) Int. Cl. G01F 23/284; G01S 13/34; G01S 7/03; G01S 13/88

(52) U.S. Cl. CPC G01F 23/284; G01S 13/88; G01S 13/34; G01S 7/03

(57) ABSTRACT

Apparatus is disclosed for detecting a first medium such as sludge having a relatively low dielectric constant wherein the first medium is located below a second medium such as water having a relatively high dielectric constant. The apparatus comprises a probe adapted to launch a pulse signal at a lower extremity thereof such that the pulse signal enters the first medium before being transferred or transmitted to the second medium. The first medium may be located at or near a bottom of a vessel and the second medium may be located above the first medium. A method for detecting the first medium located below the second medium is also disclosed.

### FIELD OF THE INVENTION

The present invention relates to a method and apparatus for detecting a medium. In particular the present invention relates to a method and apparatus for detecting a medium such as sludge having a relatively low dielectric constant when said medium is located below another medium such as water having a relatively high dielectric constant. The low dielectric medium (sludge) may be relatively more dense than the high dielectric medium (water). The present invention may make use of TDR (Time Domain Reflectometry) or another technique to detect the medium.

### BACKGROUND OF THE INVENTION

### Signal Guidance by a Sensing Element

Time Domain Reflectometry is a technique that may inject a relatively short duration impulse signal along a sensing element of a probe to identify distances to different targets along a path or medium using reflected signals. The physics behind signal guidance may be identified by first looking at how a static electric field is established between the sensing element of the probe and a vessel or tank that may contain the medium. Electric field lines typically start from a higher potential and follow a path of least resistance to a lower potential. The field lines always enter and exit perpendicularly to the conductive surface via a shortest path.

To illustrate this concept, consider a sensing element 10 of a probe mounted along the centre of a cylindrical metal tank 11 and assume a positive potential on sensing element 10, as shown in FIG. 1 (a). The voltage at any point along sensing element 10 may be given by a path integral along an electric field line from a ground potential point. If the voltage at the start of sensing element 10 is momentarily increased by injecting an impulsive signal, a perturbation may be generated to the electric field at a corresponding point. Using electromagnetic theory it may be shown that such a perturbation (shown in bold) travels along the medium, over time, as show in FIGS. 1 (a)-(c). It may also be shown that the direction of travel is perpendicular to the direction of the electric field. Therefore, the path along which the signal travels may be guided by sensing element 10.

### Speed of Signal Propagation

The speed at which a TDR signal travels may be determined by properties of the medium in which it travels. Relative permittivity (Dk) and Characteristic Impedance (Z) are two parameters that may be used to describe the medium. The signal may travel faster in material having a Lower Dk and slower in material having a higher Dk. For non-magnetic materials, the relationship between speeds of travel is given by Equation 1, wherein C_{O} is speed of signal in free space, and Dk is the effective dielectric constant. C_{O} is approximately equal to 300 mm/ns.

$$C = \frac{{C}_{0}}{\sqrt{Dk}} \qquad ( 1 )$$

### Characteristic Impedance

The characteristic impedance is a function of geometry of an associated path in addition to properties of a material. While the characteristic impedance may be analytically calculated for simple geometries, closed form solutions cannot be easily derived for many practical cases. However even in such cases, the general behaviour may be qualitatively estimated using approximate regular geometries. As an example, a cylindrical tank 20 and a centred sensing element 21 as shown in FIG. 2 may be considered as a coaxial cable whose characteristic impedance is given by Equation (2), wherein D_{Tank} and D_{Probe} denote the diameters of tank 20 and sensing element 21 respectively. For example, indicative values for characteristic impedances may be calculated for sensing element 21, water 22 and sludge 23 as shown in FIG. 2, using equation (2).

$$Z = \frac{138}{\sqrt{Dk}} log ( \frac{{D}_{Tank}}{{D}_{Probe}} ) \qquad ( 2 )$$

### Signal Propagation at Media Interface

Referring to FIGS. 3 (a) to 3 (c), signal V_{Incident} propagating in a medium may travel as a single entity so long as the characteristic impedance of the medium at a current position of the signal is the same as the characteristic impedance of the medium at a position where the signal will be at a next time instance. However if the impedances are different, for example when travelling across a material interface 24, the signal V_{Incident} may split into two parts. One part V_{Trans1} may be transferred or transmitted through interface 24 while the other part V_{Reflect1} may reflect back from interface 24. The magnitudes of the transferred and reflected signals may be determined by the characteristic impedance (Z₁) of the current medium and that of the next medium (Z₂) that defines material interface 24. The magnitudes of the reflected and transferred signals may be calculated using Equations (3) and (4). It may be observed that signal V_{Trans1} transferred through material interface 24 may be the same polarity while reflected signal V_{Reflect1} may have an inverted polarity when traveling into lower characteristic impedance Z₂.

$$\begin{matrix}{V}_{Reflect 1} = ( \frac{{Z}_{2} - {Z}_{1}}{{Z}_{2} + {Z}_{1}} ) {V}_{Incident} & ( 3 ) \\ {V}_{Trans 1} = ( \frac{2 {Z}_{2}}{{Z}_{2} + {Z}_{1}} ) {V}_{Incident} & ( 4 )\end{matrix}$$

Transmitted signal V_{Trans1} may similarly split into two parts. One part V_{Trans2} may be transferred or transmitted through interface 25 while the other part V_{Reflect2} may reflect back from interface 25. The magnitudes of the transferred and reflected signals may be similarly determined by the characteristic impedance (Z₂) of the current medium and that of the next medium (Z₃) that defines material interface 25.

### Application of TDR Technique for Detecting a Low Dielectric Medium Below a High Dielectric Medium (Detecting Underwater Level of Sludge)

Referring to FIGS. 4 (a) and 4 (b) and to examine a TDR response for a given application, sensing element 44 may be modelled as a series of transmission lines 44a, 44b, 44c with different characteristic impedances Z₁, Z₂, Z₃ as shown in FIG. 4(b). The end of sensing element 44 may appear as an open circuit. TDR instrument 40 may include electronic components such as a short duration impulse signal generator and a detector. Such components are readily available for systems with a conventional 50Ω characteristic impedance.

While practical media may have appreciable losses, the magnitude of reflected signals may be more easily calculated if losses are disregarded. Magnitudes may be calculated with respect to an initial signal launched by TDR instrument 40. Reflected signals as described below may be measured and/or calculated at a starting point of sensing element 44, and may include a sign indicating polarity.
i. Reflections from the Gas/Water interface 24 may have a relatively large magnitude and an inverted polarity.
ii. Subsequent reflections from Gas/Water interface 24 may arrive later and may have reduced magnitude compared to the first reflection. However, this magnitude may be significant when compared to other reflections of interest from media below Gas/Water interface 24, and may interfere with them.
iii. The amount of signal transferring into water after signal reaching Water/Sludge interface 25 may be minimal and may have a positive polarity.
iv. Therefore, multiple reflections from Gas/Water interface 24 may interfere/cancel with small magnitude signals from Water/Sludge interface 25.
v. Furthermore, since the amount of signal transferring into water and subsequently into sludge may have even smaller magnitude; reflection from the end of sensing element 44 may be small and may be interfered with and/or cancelled by multiple reflections from interfaces 24 and 25. Hence it may be relatively difficult to use as an inferred measurement to detect level of sludge.

The present invention may have numerous applications, including applications to detecting level of underwater sludge. It may be shown that a conventional TDR feeding system may present issues in reliably detecting sludge level at least due to:
i. The signal reflected from Water/Sludge interface 25 may be relatively small; and/or
ii. Multiple signal reflections from Gas/Water interface 24 may be relatively strong and may interfere with signals reflected from Water/Sludge interface 25.

Although a conventional TDR may be applied from the bottom of a vessel or tank to address the above issues, this may not be desirable due to:
i. Mounting restrictions as most tanks are designed with top mounts to avoid leaks of material/hazardous material;
ii. Most tanks are placed on the ground with limited access to the bottom;
iii. Maintenance and installations may require decommission of tanks;
iv. The Water/Gas interface may not be measured reliably due to reflected interference/cancelling of signals;
v. It may give rise to inaccuracy in measurement due to changes in velocity of travel of the signal in the Sludge/Water medium.

Alternatively, two separate TDR level measuring instruments may be deployed, namely one mounted from the bottom of a tank to detect a Sludge/Water interface and another one mounted from the top of the tank to measure level of a Gas/Water interface. However such an arrangement is not preferred due to the extra cost involved and the disadvantages mentioned above.

A conventional TDR probe is shown in FIG. 5. Due to the empty space 52 between inner sensing element 51 and outer conductor or shield 50, there is a tendency for foreign material to build-up and form a bridge between inner sensing element 51 and outer conductor/shield 50. Build-up of foreign material may minimise reflected signals and may cause false level detection. The present invention may alleviate the effect of such bridging or material build-up by partially filling the empty space 52 and/or by adopting a partly open geometry for conductor/shield 50 of the probe.

The present invention may alleviate the disadvantages of the prior art or at least may provide the consumer with a choice.

A reference herein to a patent document or other matter which is given as prior art is not to be taken as an admission that that document or matter was known or that the information it contains was part of the common general knowledge in Australia or elsewhere as at the priority date of any of the disclosure or claims herein. Such discussion of prior art in this specification is included to explain the context of the present invention in terms of the inventor's knowledge and experience.

Throughout the description and claims of this specification the words “comprise” or “include” and variations of those words, such as “comprises”, “includes” and “comprising” or “including, are not intended to exclude other additives, components, integers or steps.

### SUMMARY OF THE INVENTION

According to one aspect of the present invention there is provided an apparatus for detecting a first medium having a relatively low dielectric constant wherein said first medium is located below a second medium having a relatively high dielectric constant, said apparatus comprising a probe adapted to launch a pulse signal at a lower extremity thereof such that said pulse signal enters said first medium before being transferred or transmitted to said second medium.

The first medium may be located at or near a bottom of a vessel and the second medium may be located above the first medium. The probe may be adapted to be mounted through a top of the vessel. The first medium may be relatively dense and may include sludge and the second medium may be less dense and may include water and/or a gas.

The probe may include a sensing element and a signal feed line for interfacing the sensing element at or near a lower extremity thereof. The sensing element may include a stainless steel rod and a conducting shield and the feed line may include a coaxial cable. The probe may include a non-conducting core and the shield may include a geometry in cross-section adapted to eliminate or at least reduce build-up of foreign material between the rod and the shield. The probe may include an impedance matching circuit between the stainless steel rod and the coaxial cable. The apparatus may include plural feed lines connected to a bottom extremity of the probe for measuring multiple interface levels.

The apparatus may include one or more additional feed lines connected to a top extremity of the probe for performing a conventional measurement of low dielectric to high dielectric interface.

The apparatus may be adapted to employ one or more of Time Domain Reflectometry (TDR), Frequency Modulated Continuous Wave (FMCW) and/or Stepped Frequency Continuous Wave (SFCW) techniques.

The apparatus may include a transmitter/receiver in combination with a controllable switch matched to the signal feed line for launching the pulse signal.

The apparatus may be adapted for measuring single or multiple levels/interfaces and for outputting measures of single or multiple levels/interfaces respectively.

According to a further aspect of the present invention there is provided a method for detecting a first medium having a relatively low dielectric constant wherein said first medium is located below a second medium having a relatively high dielectric constant, said method comprising providing a probe; and arranging said probe to launch a pulse signal at a lower extremity thereof such that said pulse signal enters said first medium before being transferred or transmitted to said second medium.

The present invention may provide a more reliable indication of underwater sludge level and/or an additional level of Gas/Water interface.

### DESCRIPTION OF THE DRAWINGS

FIGS. 1(a) to 1 (c) show TDR signal guidance along a sensing element associated with a probe;

FIG. 2 shows characteristic impedances associated with different media (Gas, Water, Sludge);

FIGS. 3 (a) to 3 (c) show signal reflections at interfaces between different media (Z1, Z2, Z3);

FIGS. 4 (a) and 4 (b) show a conventional (top-down) probe model for TDR application;

FIG. 5 shows a conventional coaxial TDR probe;

FIGS. 6 (a) and 6 (b) show a bottom-up probe model for TDR application according to an embodiment of the present invention;

FIGS. 7 (a) to 7 (c) show a TDR probe mounting, a probe with a single sensing element, and a probe with multiple sensing element respectively; and

FIG. 8 shows an instrument for launching pulses to multiple sensing elements.

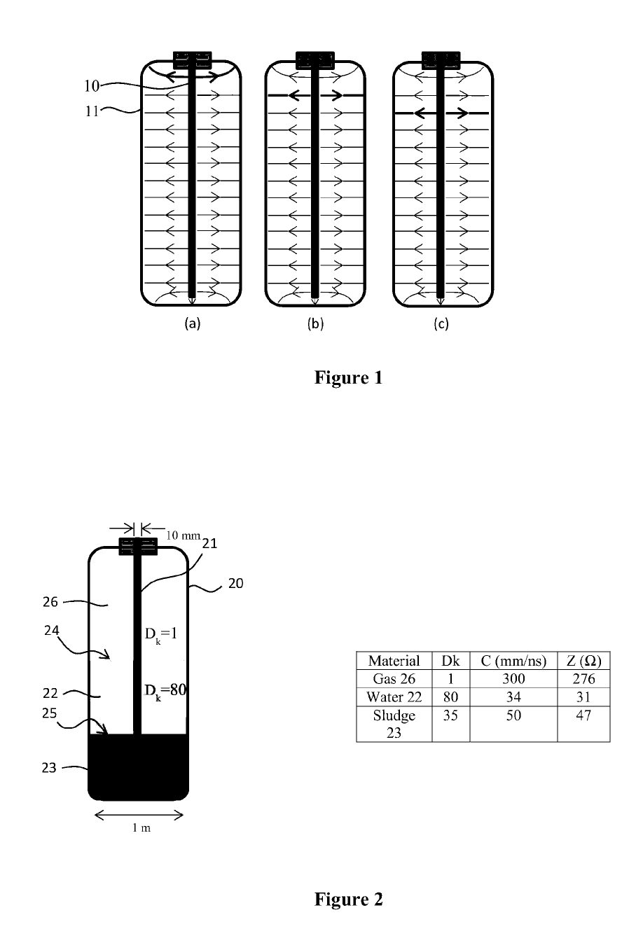

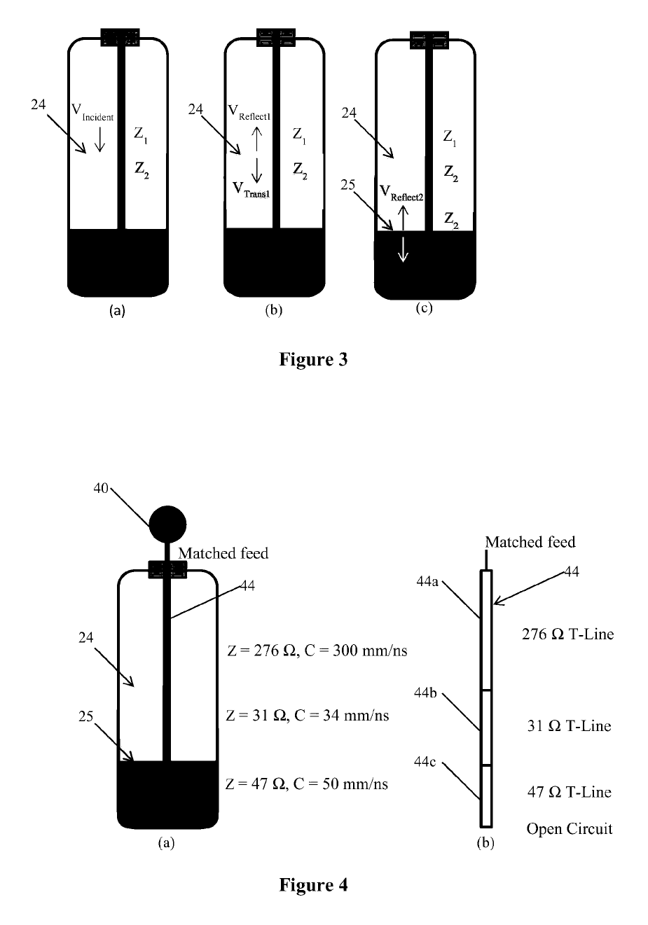

### DESCRIPTION OF A PREFERRED EMBODIMENT

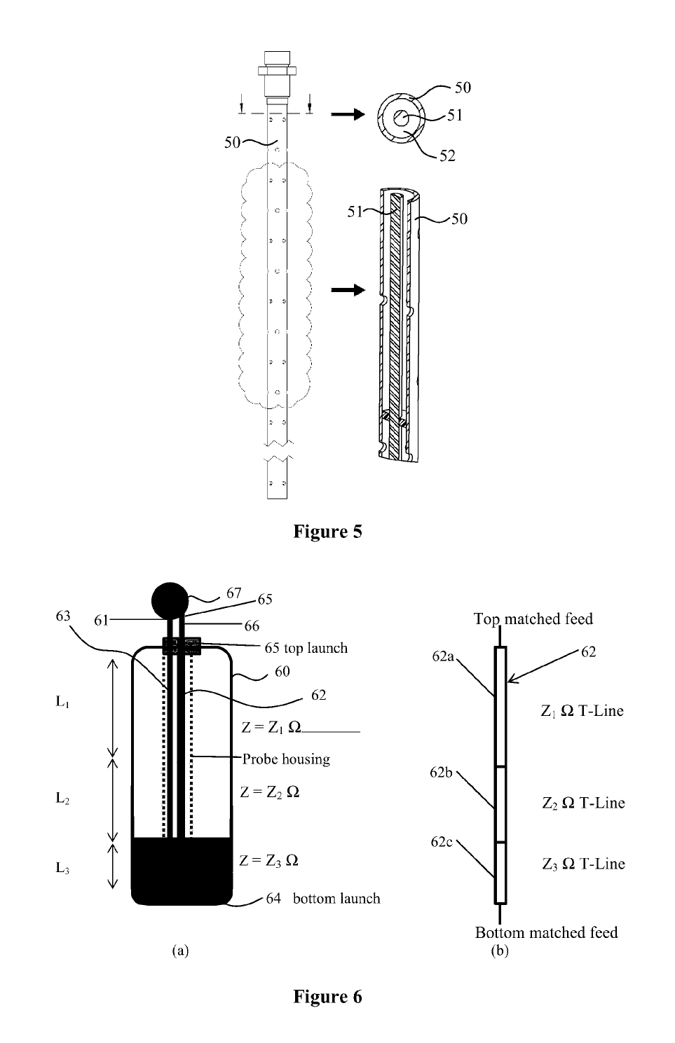

The present invention may provide an alternative approach to the conventional TDR probe illustrated in FIG. 4 (a). In particular, the present invention may make use of a “bottom-up” feed arrangement as shown in FIG. 6. In the “bottom-up” arrangement shown in FIG. 6 (a), an impedance matched first signal feed 61 from TDR instrument 67 is extended to the bottom of sensing element 62 via shielded coaxial cable 63, and is launched from the bottom of vessel 60 towards the top. A suitable impedance matching circuit (not shown) may be provided between coaxial cable 63 and sensing element 62. Sensing element 62 may be provided in any suitable form such as a stainless steel rod or the like. As described with reference to FIG. 4(b) sensing element 62 may be modelled as a series of transmission lines 62a, 62b, 62c with different characteristic impendences Z₁, Z₂, Z₃ as shown in FIG. 6b. An impedance matched second signal feed 65 from TDR instrument 62 may be connected to the top of sensing element 67 via coaxial cable 66.

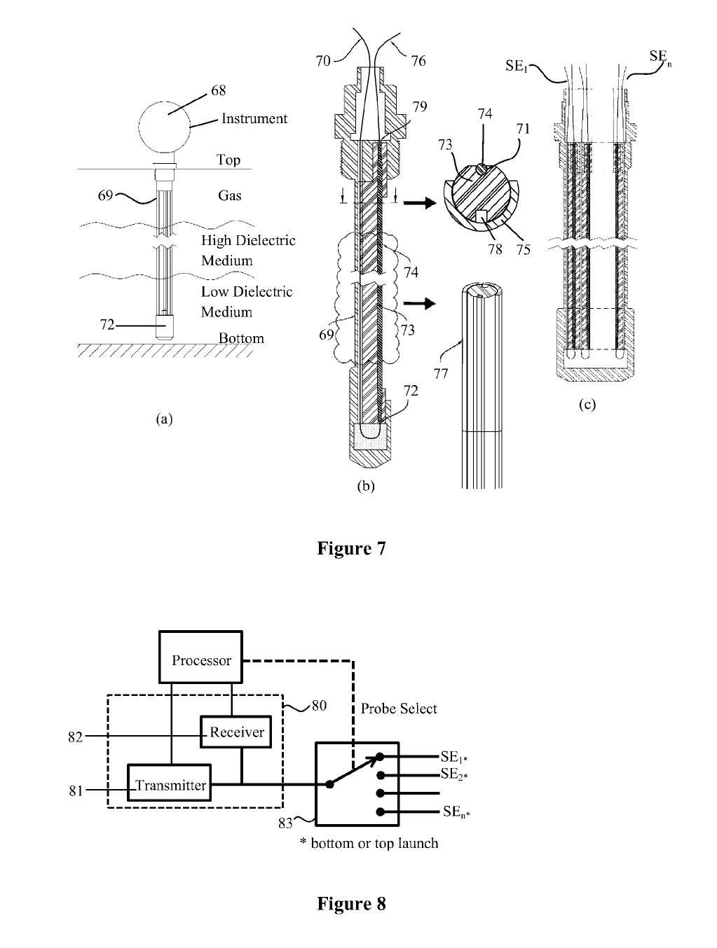

FIG. 7(a) shows one form of mounting for instrument 68 and associated TDR probe 69 atop a storage tank including a top and bottom and including gas, high dielectric medium and low dielectric medium below the high dielectric medium. Probe 69 includes a sensing element and a signal feed line for launching a TDR signal at or near a lower extremity 72 thereof. This configuration may be adapted to detect the low dielectric medium below the high dielectric medium.

The sensing element may comprise a single sensing element and associated feed line as shown in FIG. 7b. The sensing element may include an elongated stainless steel rod 74 and outer shield 75 and the feed line may include coaxial cable 70 for bottom up sensing and coaxial cable 76 for top down sensing. The sensing element may include an impedance matching circuit between stainless steel rod 74 and coaxial cable 70 (not shown).

Alternatively there may be provision to attach to top extremity 79 of probe 69, multiple sensing elements and associated feed lines SE1 to SEn as shown in FIG. 7c to measure multiple interface levels. This configuration may facilitate measurement of a Gas/Water (low dielectric to high dielectric) interface via a conventional TDR technique.

As described above the probe of the present invention may alleviate a tendency for foreign material to build-up or form a bridge in the empty space 52 between inner sensing element 51 and outer conductor/shield 50 associated with the conventional TDR probe shown in FIG. 5.

Bridging may be reduced or at least alleviated by partly filling the empty space 52 and/or by adopting a partly open geometry for outer conductor/shield 50. To this end and referring to the cross sectional view in FIG. 7(b), probe 69 may include a partly open or arcuate outer conductor/shield 75. In one form conductor/shield 75 may be semi-annular or half-annular in cross-section.

Probe 69 may include a substantially cylindrical core 73 formed from a non-conducting, low dielectric material such as Teflon. Core 73 may be positioned between conductor/shield 75 and stainless steel rod 74, such that rod 74 is at least partly or substantially exposed to the medium.

It is desirable to maintain at least a 10 mm distance between rod 74 and shield 75. Core 73 includes a longitudinal slot 78 for receiving coaxial cable 70 therein. Core 73 includes a longitudinal recess 71 for receiving part of stainless steel rod 74 such that rod 74 remains substantially exposed to the medium. FIG. 7(b) includes a perspective view 77 of the geometry of the sensing element.

FIG. 8 shows electronics 80 associated with instrument 68 for launching pulses to multiple sensing elements SE1 to SEn. Electronics 80 includes transmitter 81 for generating pulses and receiver 82 for receiving echoes of the pulses.

The present invention may provide a modified TDR feeding arrangement including a shielded line to launch a TDR pulse signal from the bottom or top of one or more sensing elements. In particular electronics 80 may be used in conjunction with an electronically controllable switch 83 matched to the or each shielded line to launch the pulse signal from the bottom or top of sensing elements SE1-SEn. This technique may provide an advantage in that a signal launched from the bottom may minimise attenuation of reflected signal from a low to high dielectric interface (eg. Sludge/Water interface) while a signal launched from the top may allow detection of a Gas/Water interface.

Alternatively by using a single sensing element and switching the launch signal from the bottom to the top as described above, the probe of the present invention may avoid a need for two separate instruments to measure level of a medium.

Reflected signals resulting from a bottom-up feed arrangement may detect a low dielectric/high dielectric (Sludge/Water) interface as follows:
i. Since the signal is launched into a low dielectric medium, it may have a closely matched feed impedance. Since probe dimensions may be controlled, the resulting impedance may be better matched, and may be independent from tank dimensions;
ii. Since the signal travels a minimal distance within the medium, it may not be subjected to heavy attenuation;
iii. Therefore a higher signal may be reflected from the interface of low to high dielectric compared to a conventional method and, furthermore since this reflection is the first to be received by electronics 80, it may not be interfered with by multiple reflections.

From the above analysis it may be seen that a bottom-up feed arrangement may provide several advantages including:
i. Reflected signals from Sludge/Water interface may arrive first and hence may not be interfered by other signal reflections;
ii. Attenuation of the reflected signal from Sludge/Water interface may be relatively minimal;
iii. Reflected signals from Sludge/Water interface may have negative polarity while the Water/Gas interface may generate a reflected signal with positive polarity. Hence both interfaces may be more distinctive.

Although a preferred embodiment the present invention may make use of a TDR technique for detecting a low dielectric medium below a high dielectric medium, the present invention is not thereby limited to such techniques and is equally capable of using techniques other than TDR techniques including but not limited to Frequency Modulated Continuous Wave (FMCW) and Stepped Frequency Continuous Wave (SFCW) techniques.

Finally, it is to be understood that various alterations, modifications and/or additions may be introduced into the constructions and arrangements of parts previously described without departing from the spirit or ambit of the invention.

1. Apparatus for detecting a first medium having a relatively low dielectric constant wherein said first medium is located below a second medium having a relatively high dielectric constant, said apparatus comprising a probe adapted to launch a pulse signal at a lower extremity thereof such that said pulse signal enters said first medium before being transferred or transmitted to said second medium.

2. Apparatus according to claim 1 wherein said first medium is located at or near a bottom of a vessel and said second medium is located above said first medium.

3. Apparatus according to claim 2 wherein said probe is adapted to be mounted through a top of said vessel.

4. Apparatus according to claim 1, wherein said first medium is relatively dense and includes sludge and said second medium is less dense and includes water and/or a gas.

5. Apparatus according to claim 1, wherein said probe includes a sensing element and a signal feed line for interfacing said sensing element at or near a lower extremity thereof.

6. Apparatus according to claim 5 wherein said sensing element includes a stainless steel rod and a conducting shield and said feed line includes a coaxial cable.

7. Apparatus according to claim 5 wherein said probe includes a non-conducting core and said shield includes a geometry in cross-section adapted to eliminate or at least reduce build-up of foreign material between said rod and said shield.

8. Apparatus according to claim 6 wherein said probe includes an impedance matching circuit between said stainless steel rod and said coaxial cable.

9. Apparatus according to claim 1 further including plural feed lines connected to a bottom extremity of said probe for measuring multiple interface levels.

10. Apparatus according to claim 1 further including one or more additional feed lines connected to a top extremity of said probe for performing a measurement of a low dielectric to high dielectric interface.

11. Apparatus according to claim 1 wherein said apparatus is adapted to employ one or more of Time Domain Reflectometry (TDR), Frequency Modulated Continuous Wave (FMCW) and/or Stepped Frequency Continuous Wave (SFCW) techniques.

12. Apparatus according to claim 5 further including a transmitter/receiver in combination with a controllable switch matched to said signal feed line for launching said pulse signal.

13. Apparatus according to claim 12 and adapted for measuring single or multiple levels/interfaces and for outputting measures of single or multiple levels/interfaces respectively.

14. A method for detecting a first medium having a relatively low dielectric constant wherein said first medium is located below a second medium having a relatively high dielectric constant, said method comprising providing a probe; and arranging said probe to launch a pulse signal at a lower extremity thereof such that said pulse signal enters said first medium before being transferred or transmitted to said second medium.

15. A method according to claim 14 wherein said first medium is located at or near a bottom of a vessel and said second medium is located above said first medium.

16. Method according to claim 15 including mounting said sensing element through a top of said vessel.

17. A method according to claim 14, wherein said first medium is relatively dense and includes sludge and said second medium is less dense and includes water and/or a gas.

18. A method according to claim 14 wherein said probe includes a sensing element and a signal feed line for interfacing said sensing element at or near a lower extremity thereof.

19. A method according to claim 18 wherein said sensing element includes a stainless steel rod and a conducting shield and said feed line includes a coaxial cable.

20. A method according to claim 18 wherein said probe includes a non-conductive core and said shield includes a geometry in cross-section adapted to eliminate or at least reduce build-up of foreign material between said rod and said shield.

21. A method according to claim 19 wherein said probe includes an impedance matching circuit between said stainless steel rod and said coaxial cable.

22. A method according to any one of claim 14 further including connecting plural feed lines to a bottom extremity of said probe for measuring multiple interface levels.

23. A method according to any one of claim 14 further including connecting one or more additional feed lines to a top extremity of said probe for performing a conventional measurement of a low dielectric to high dielectric interface.

24. A method according to claim 14 further including employing one or more of Time Domain Reflectometry (TDR), Frequency Modulated Continuous Wave (FMCW) and/or Stepped Frequency Continuous Wave (SFCW) techniques.

25. A method according to claim 14 further including using a transmitter/receiver in combination with a controllable switch matched to said signal feed line for launching said pulse signal.

26. A method according to claim 25 and adapted for measuring single or multiple levels/interfaces and for outputting measures of single or multiple levels/interfaces respectively.
